(19) United States
(12) Patent Application Publication
(10) Pub. No.: US 2009/0292619 A1
(43) Pub. Date: Nov. 26, 2009

(54) METHOD FOR UNIVERSAL ELECTRONIC PAYMENT PROCESSING

(76) Inventors: Gershon Kagan, Bet Shemesh (IL); Peretz Rickett, Alon Shvut (IL)

Correspondence Address: GREENBLUM & BERNSTEIN, P.L.C., 1950 ROLAND CLARKE PLACE, RESTON, VA, 20191, US

(21) Appl. No.: 12/295,798

(22) PCT Filed: Apr. 2, 2007
(86) PCT No.: PCT/US07/65794

§ 371 Date: Oct. 2, 2008

Related U.S. Application Data
(60) Provisional application No. 60/788,117, filed on Apr. 3, 2006.

(51) Int. Cl. G06Q 20/00; G06Q 30/00; G06Q 40/00; G06F 17/30; G06Q 50/00; H04L 9/32

(52) U.S. Cl. 705/26; 705/34; 705/40; 705/44; 707/10; 726/5; 707/104.1; 707/E17.107

(57) ABSTRACT

An efficient, secure method for processing an electronic transaction among a user (101), a billing service provider (112), a merchant (123) and a transaction facilitator (132) is provided using a transaction facilitator server (131) accessible via a data network (50). Billing service providers (112) include, for example, internet service providers, telephone service providers, banks, or credit card companies. Product information and a merchant identifier are received from a merchant server (122) in response to a user's purchase request. The user (101) is connected to the billing service provider server (111) in order to authorize the transaction based on the user's account information. The transaction facilitator server (131) and merchant server (122) receive an authorization response from the billing service provider server (111) indicating whether the transaction has been approved or denied. Neither the transaction facilitator server (131) nor the merchant server (122) receive the user's account information. The user (101) is redirected to the merchant server (122), completing the purchase request based on the authorization response.

This application claims priority of U.S. Provisional Patent Application No. 60/788,117, filed on Apr. 3, 2006, the disclosure of which is expressly incorporated by reference herein in its entirety.

### BACKGROUND OF THE INVENTION

1. Field of the Invention

The present invention relates to the field of electronic commerce. More particularly, the present invention relates to efficiently, securely, and conveniently processing electronic payments using the Internet or other commonly accessible data network.

2. Background Information

Marketing experience has shown that merchants offering products and services over the World Wide Web are interested in a payment process that brings them revenue immediately, without relying on other operators simultaneously adopting the same platform, without relying on future developments, and without requiring business process shifts. Additionally, facilitating secure, easy purchases over the Internet may spur growth, not only of traditional on-line purchases, but also cell phone-based purchases. Off-portal revenues are becoming more important, as web services in telephony become even more popular, and cell phones evolve in capacity to resemble conventional laptops.

On-line purchases have traditionally suffered from a number of drawbacks, including a perceived lack of security, cumbersome check out techniques, and the need to register with different merchants individually and to remember the login and password for each merchant. Many on-line payment systems charge users settlement fees (e.g., an additional fee for conducting the transaction), making micropayments (i.e., very small amounts of money, such as less than 1 USD) unprofitable, except for payment schemes that require both merchants and users to sign up directly with the payment scheme provider.

Accordingly, consumers may avoid making on-line purchases due to privacy concerns, lack of familiarity with on-line merchants and third party broker systems, or lack of credit cards or bank accounts. Even a technically savvy user, who is familiar with on-line purchase methods, may avoid websites that require completion of lengthy forms, requiring private information as part of the purchasing process. Also, many consumers are not using the Internet for purchases at all because they do not want to provide credit card information or other sensitive financial data on-line, especially for small purchases and with unfamiliar merchants.

Traditional on-line payment methods have a number of drawbacks. For example, third party systems, which broker payments among a consumer, the merchant, and the consumer's bank or other billing service provider, require the consumer to open an account in advance of a purchase and to provide payment information, such as credit card numbers or bank accounts. Some consumers feel uncomfortable due to lack of familiarity with such third party brokers, and may also be wary of learning a different purchasing process for each site. Furthermore, from the perspective of billing service providers, another disadvantage of third party broker systems is the inability to meet the security needs of each billing service provider.

Although other online payment systems (such as Premium SMS (short message service)) do not include third party brokers (that the consumer must sign up with) and allow consumers to make on-line purchases through the user's telephone provider, these systems have no outside accounting system. Furthermore, Premium SMS does not support arbitrary purchase amounts, is prone to revenue leakage, and requires setup with multiple operators individually to approach global coverage. Also, premium SMS (like purchasing credit cards) is not economical to merchants for small payments.

The present invention overcomes the problems associated with the prior art, as described above.

### SUMMARY OF THE INVENTION

An objective of the present invention is to provide an efficient and secure method for processing an electronic transaction among a user, a billing service provider, a merchant, and a transaction facilitator using a transaction facilitator server accessible via a data network. Billing service providers include, but are not limited to, internet service providers, a telephone service providers, banks, or credit card companies.

In one embodiment, this method entails receiving product information and a merchant identifier from a merchant server in response to a purchase request by the user. The user is connected to the billing service provider service in order to authorize the transaction based on the user's account information. The transaction facilitator server and merchant server receive an authorization response from the billing service provider server indicating whether the transaction has been approved or denied. However, neither the transaction facilitator server nor the merchant service receive the user's account information. The user is redirected to the merchant server, completing the purchase request based on the authorization response.

The aforementioned merchant identifier may include a uniform resource locator (URL) of a website stored on the merchant server. Also, the authorization response may be based on identifying the user and determining that funds are available in the user's account to cover the transaction.

In an embodiment, the step relating to identification of the user includes verifying a predetermined username and a predetermined password. The identity of the user may also include the user computer's IP address or other unique identifier.

In one embodiment, before the user is connected to the billing service provider server, the merchant server (or transaction facilitator server) may provide the user a list of billing service providers, e.g., based upon the IP address of the user. In response, the user may select and input a billing service provider.

Alternatively, the system may determine whether the user has registered on the billing service provider server, and connect the user to that billing service provider server. Once the user has been connected to the billing service provider service, the user may be redirected to a registration site if the user has not previously registered on the billing service provider server.

The billing service provider server may further authenticate the user's identity by calling the user's phone number stored on the billing service provider database from an interactive voice response (IVR) system, or by sending the user's cellular phone an SMS (short message system) message, which supplies the user a code to enter on a billing service provide authorization page.

In addition to the user's identity being authenticated, the transaction may be authorized, and an authorization response is sent from the billing service provider server. In one embodiment, this authorization response may based upon the user's account balance information. Once the user's identity has been authenticated and the transaction has been approved by the billing service provider server, the transaction is completed and digital content or real content is delivered to the user by the merchant (or merchant server).

The transaction facilitator server may request and receive the user's check balance due from the merchant via the Internet or other network. The transaction facilitator server may also access a database to retrieve balance due data corresponding to each merchant. During this settlement process, in one embodiment, the transaction facilitator server may send aggregate transaction data of billing service provider and merchant pairs to a financial clearing and settlement provider, wherein the billing service provider and the merchant are identified only by predetermined numerical values. An aggregate invoice, comprising transaction data, is generated and sent to at least one billing service provider. In order to further ensure the efficiency of the settlement process, the transaction facilitator server receives notification of funds transferred from the billing service provider to the merchant.

Another aspect of the invention includes an apparatus, accessible via a data network, for processing an electronic transaction of a user. The apparatus includes at least two interfaces. The first interface is configured to receive product information and a merchant identifier from the merchant server in response to a purchase request by the user. The second interface is configured to connect the user to the billing service provider server for authorizing the transaction based on the user's account information, and to receive an authorization response from the billing service provider server indicating whether the transaction has been approved or denied, without receiving the account information. In this embodiment, the user is redirected to the merchant server via the first interface, and the merchant server completes the purchase request based on the authorization response.

In an embodiment, the merchant and the billing service provider may be authenticated via cookies in a browser of the user. Also, the second interface may be further configured to receive a second authentication response verifying an identity of the user based on a predetermined password provided by the user. In one embodiment, the billing service provider server may also include a database which stores a pre-authorized amount of funds and/or the user's credit card identification information.

Another aspect of the invention encompasses a computer readable medium for storing a computer program executed by a computer that processes an electronic transaction among a user, a billing service provider, a merchant, and a transaction facilitator using a transaction facilitator server accessible via a data network.

The computer readable medium includes a number of code segments: a receiving code segment for receiving product information and a merchant identifier from a merchant server in response to a purchase request by the user; a connecting code segment for connecting the user to a server of the billing service provider for authorizing the transaction based on account information of the user; an authorization code segment for receiving an authorization response from the billing service provider server indicating whether the transaction has been approved or denied, without receiving the user account information; and a redirecting code segment for redirecting the user to the merchant server, which processes the purchase request based on the authorization response. In an embodiment, the account information may also include credit card number and/or a debit card identifier.

Another aspect of the invention encompasses a method for implementing an on-line debit card using a billing service provider server accessible via a data network. Billing service providers include, but are not limited to, internet service providers, telephone service providers, banks, or credit card companies. The method includes storing a user's account information in a billing service provider's database, where the user's account information includes an amount of funds identified by the user for electronic transactions. The user's account information may also include the user's IP address.

The billing service provider server receives a connection with the user to authorize a transaction requested by the user at a merchant website, and information identifying the merchant website. The transaction also includes a payment amount. The billing service provider server authorizes the payment amount based on the user's account information, and the merchant website receives notice of the authorized payment amount without receiving the user's account information.

In one embodiment, the billing service provider server transmits an authorization response to the user indicating whether the payment amount been authorized. The billing service provider server may also identify the user or authenticate the user's identity, and the authorization response may be based on identifying the user or authenticating the user's identity. The user's identity may be authenticated by verification of a predetermined password. Alternatively, the user's identity may be authenticated by contacting the user by calling or sending an electronic message to the user, and supplying a code for the user to enter.

In an embodiment, the billing service provider server debits the payment amount from the identified funds. The billing service provider server may also refresh remaining funds to the amount of identified funds. The remaining funds may be refreshed automatically or based upon a request by the user.

In view of the above, the present invention through one or more of its various aspects and/or embodiments is presented to accomplish one or more objectives and advantages, such as those noted below.

The various aspects and embodiments of the present invention are described in detail below.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a block diagram depicting an exemplary architecture, according to an aspect of the present invention;

FIG. 2 is a flowchart depicting an exemplary transaction flow among a user, a merchant, a transaction facilitator and a billing service provider, according to an aspect of the present invention;

FIG. 3 is a flowchart depicting an exemplary process by which money is exchanged among the user, a merchant and a billing service provider, according to an aspect of the present invention;

FIG. 4 is a flowchart depicting an exemplary process for providing additional security for the electronic transaction among a user, a billing service provider server, a merchant payment server and a transaction facilitator, according to an aspect of the present invention; and

FIG. 5 is a flowchart depicting an exemplary process for the transaction facilitator server.

### DETAILED DESCRIPTION OF EMBODIMENTS

As stated above, the present invention is directed to a system and method for facilitating electronic payment transactions, which allow users to pay on-line merchants through a number of possible billing service providers (including, but not limited to, credit card companies, banks, internet service providers (ISPs), and telephone companies), without having to provide personal account information to the merchant or to a third party billing system. The present invention also allows the user's billing provider to modify user account authorization process to suit the billing provider's security needs. The present invention may also facilitate real-time transaction processing, identity management, user authentication, and payment authorization.

The present invention also enables the merchant and billing service providers to separately communicate with a transaction facilitator server to complete a transaction, without having to directly communicate with each other. The system is also configured such that no one except the billing service provider knows the user's identity and can authenticate the user.

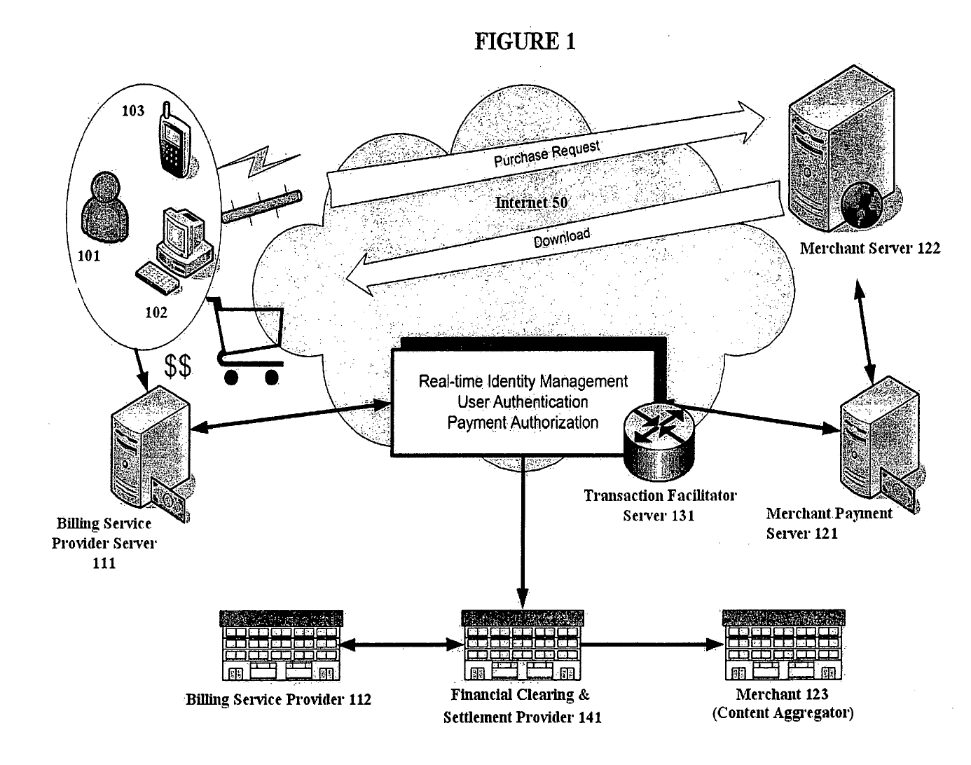

FIG. 1 is a block diagram depicting an exemplary architecture of the transaction facilitating system, according to an embodiment of the present invention. The electronic transaction is typically initiated by a user 101, which accesses the Internet 50, or other data network, using a network compatible client device, such as a personal computer 102 at home or work, or a mobile device 103. The personal computer 102 may be, for example, a conventional IBM PC, running a Windows operating system (OS), Linux OS, or the like, having a Internet connection and running a web browser, such as Microsoft Windows Explorer. The mobile device 103 may be, for example, a cell phone or a personal digital assistance with an Internet connection and web or WAP (wireless application protocol) browser. It is understood that reference to the user 101 includes the client device, e.g., the personal computer 102 and the mobile device 103, and the corresponding software for enabling communications.

In an embodiment, the user 101 may be an individual or institution. The user 101 has a preexisting account with a billing service provider 112. The billing service provider 112 may include, for example, a number of financial institutions. For example, the billing service provider 112 may be an Internet service provider (ISP), a telephone company, a bank, a credit card company or the like. The billing service provider 112 has an on-line billing service provider server 111, which stores financial records and other account information on clients, such as the user 101. Accordingly, the user 101 may have a billing service provider customer identification number or other identification, corresponding to the preexisting account. The user 101 may also have a transient account with a billing service provider. For example, the user 101 may use funds on a prepaid telephone calling card from a telephone company, or other such prepaid and/or rechargeable card or account, to pay for downloads, goods and services.

The financial transaction takes place when the user 101 desires to make a purchase, for example, from a merchant 123. The merchant 123 may be a commercial vendor, or any other public or private organization, having a web presence, and who sells digital content or real goods and/or services. The merchant 123 has a merchant server 122, which stores and/or accesses information on the goods and services, including, for example, digital content, sold by the merchant 123, including web pages and databases. For example, the merchant server 122 may allow the user 101 to purchase and download digital content, including ring tones, electronic wallpaper, video clips, games, etc. Of course, the merchant server 122 likewise may store information on real goods and services, which may be purchased and delivered by the user 101.

In an embodiment, the merchant 123 also has a merchant payment server 121, which processes payments and handles account information. The merchant payment server 121 stores merchant web pages related to the payment process, customer account information in merchant databases, application program interface (API) files, and enables the merchant 123 to receive and store information on transactions. The merchant server 122 and the merchant payment server 121 may be implemented by the same or different server devices, without departing from the spirit or scope of the present invention. The merchant payment server 121 may be a shopping cart checkout system, for example, either internal to the merchant or as a hosted service. The merchant payment server 121 and the merchant server 122 may include a commercial web or WAP site. Also, the merchant payment server 121 and the merchant server 122 may implement transaction facilitator program libraries in directories and add code snippets of four essential function calls in the merchant web page script, discussed below. Alternatively, the functionality of merchant payment server 121 may also be implemented in merchant server 122.

A financial clearing and settling provider 141 is an entity that provides financial settlement and funds transfer between the billing service provider 112 and merchant 123 pursuant to the on-line financial transactions instigated by the user 101. For example, the financial clearing and settling provider 141 generates invoices and transfers funds for transactions between the merchant 123 and the billing service provider 112 whenever the billing service provider 112 is accessed by the user 101 and a transaction facilitator server 131 in the course of enabling an on-line transaction. This information may be stored in a database on a server (not pictured) of the financial clearing and settling provider 141.

The transaction facilitator server 131 facilitates the transaction among the various parties to the on-line transaction, redirecting and routing the user 101 among the merchant server 122, the merchant payment server 121, and the billing service provider server 111. In an embodiment, the transaction facilitator server 131 runs on a single dedicated web hosting service; however, it is not limited to this implementation, and may be highly scalable. For example, the transaction facilitator server 131 may incorporate the LAMP suite (Linux, Apache, MySQL, PHP), and thus can process large numbers of transactions distributed across multiple servers. Also, using database scripting languages (e.g., PHP and MySQL), the transaction facilitator server 131 may generate monthly aggregate transaction reports, which are used by the financial clearing and settlement provider 141 to transfer funds from the billing service provider 112 to the merchant 123.

Although FIG. 1 depicts a number of servers, it is understood that disclosed system may encompass various combinations of software, firmware and hardware implementations. Further, the methods described herein may be implemented by software programs executable by any capable computer system, of which a server is one example. In an exemplary, non-limited embodiment, implementations can include distributed processing, component/object distributed processing, and parallel processing. Alternatively, virtual computer system processing can be constructed to implement one or more of the methods or functionalities as described herein.

Also, it is further understood that the software may be stored for execution by the computer system on a computer-readable medium, which may include a single medium or multiple media, such as a centralized or distributed database, and/or associated caches and servers that store one or more sets of instructions. The term computer-readable medium may also include any medium that is capable of storing, encoding or carrying a set of instructions for execution by a processor, or that cause the computer system to perform any one or more of the methods or operations disclosed herein.

The computer-readable medium may further include a solid-state memory, such as a memory card, that houses one or more non-volatile read-only memories. Further, the computer-readable medium can be a random access memory or other volatile re-writable memory. Additionally, the computer-readable medium can include a magneto-optical or optical medium, such as a disc or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

As stated above, the merchant 123 may store program libraries in merchant payment server 121 by downloading directories and code snippets from the transaction facilitator server 131. These code snippets are added to merchant web pages, and perform essential function calls in the merchant web page script. For example, a first function is the begin or initialization function call, which is called when the user 101 selects a product for purchase. The initialize function call begins the transaction process by sending transaction information (including the required merchant data, such as a merchant transaction identifier, product price, a currency identifier, and a text description of the purchase or transaction) to transaction facilitator server 131.

Another function call is the select biller function call, which receives and outputs a list of registered billing service providers on the merchant website. The contents of the list depends upon information associated with the user 101, such as the geographic location or country of the user 101 (e.g., based upon an IP address of the PC 102 or the mobile device 103) and previously used billing service providers (e.g., based upon cookies saved in the user's browser).

The query function call optionally requests and receives a transaction token confirming the status of a particular transaction from the transaction facilitator server 131. This function call may reserve or halt the transaction process in the billing service provider server 111, until the requested transaction status has been received. Based on the output of the query function call, the merchant payment server 121 can determine whether the transaction has been approved.

There may also be a finalize function call, which requests and receives a transaction token from the billing service provider server 111 confirming that the transaction has been finalized. The finalize function call completes the transaction process and charges the user's account with billing service provider 112. In one embodiment, the user will not be charged until transaction is approved and the merchant payment server 121 calls this method. Alternatively, the query and the finalize functions calls may be combined into a single function call, which does not reserve or halt the transaction process in the billing service provider server 111 until the transaction status has been received.

In one embodiment, the code snippets create an icon on the merchant's web page, which identifies the transaction facilitator server 131 and allows the user 101 to initiate the transaction process. The code snippets are downloadable to the merchant payment server 121 and/or the merchant server 122, in the form of an API. The merchant 123 may download the code to the merchant payment server 121 and/or the merchant server 122 from transaction facilitator server 131 or from an electronic storage medium (such as a floppy disc, compact disc, flash drive, or other such computer readable media) delivered to merchant 123 from transaction facilitator 132.

In an embodiment, the software requirements for the merchant server 122 are intentionally kept at a minimum. The required functionality may be provided simply by updating the merchant website with a minimal API. The API may be provided, for example, by the transaction facilitator 132, according to whatever arrangement is made between the two entities, such as payment of a monthly fee or the like. As stated above, the API includes software that presents an icon, representing the transaction facilitator server 131 on the merchant's web page presented to the user 101. Exemplary merchant server interface APIs include, but are not limited to, the following platforms: PHP, .NET, ASP, Java.

Likewise, there are few technical requirements for the user's computing devices, such as the personal computer 102 and the mobile device 103. For example, in order to interact with the transaction facilitator server 131, the computing device of the user 101 at least needs an installed web browser that accepts cookies, or a WAP browser.

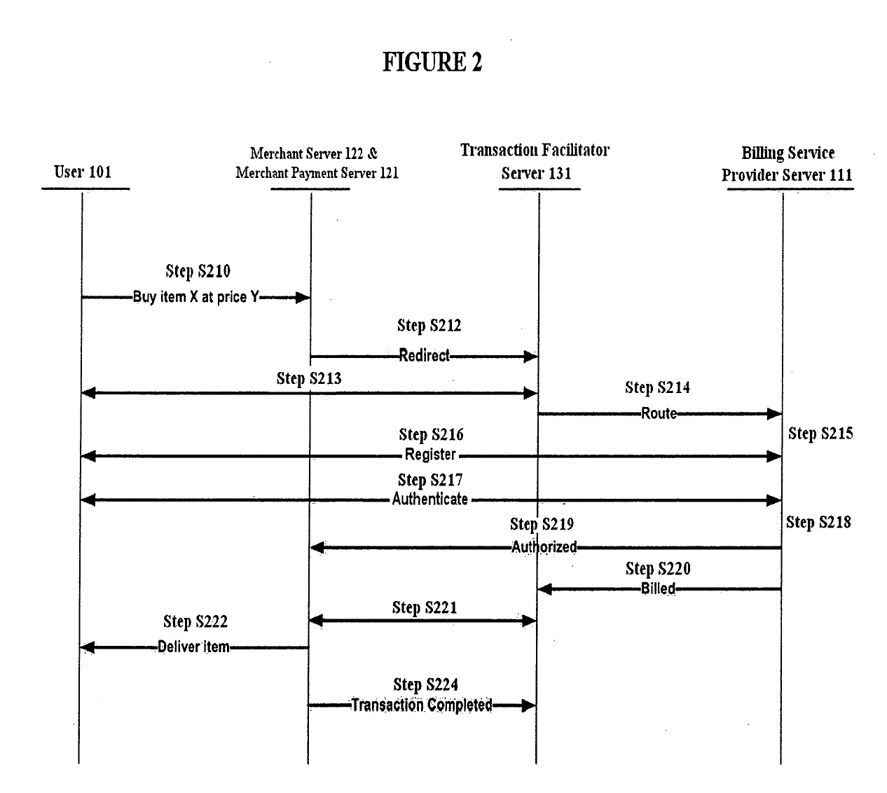

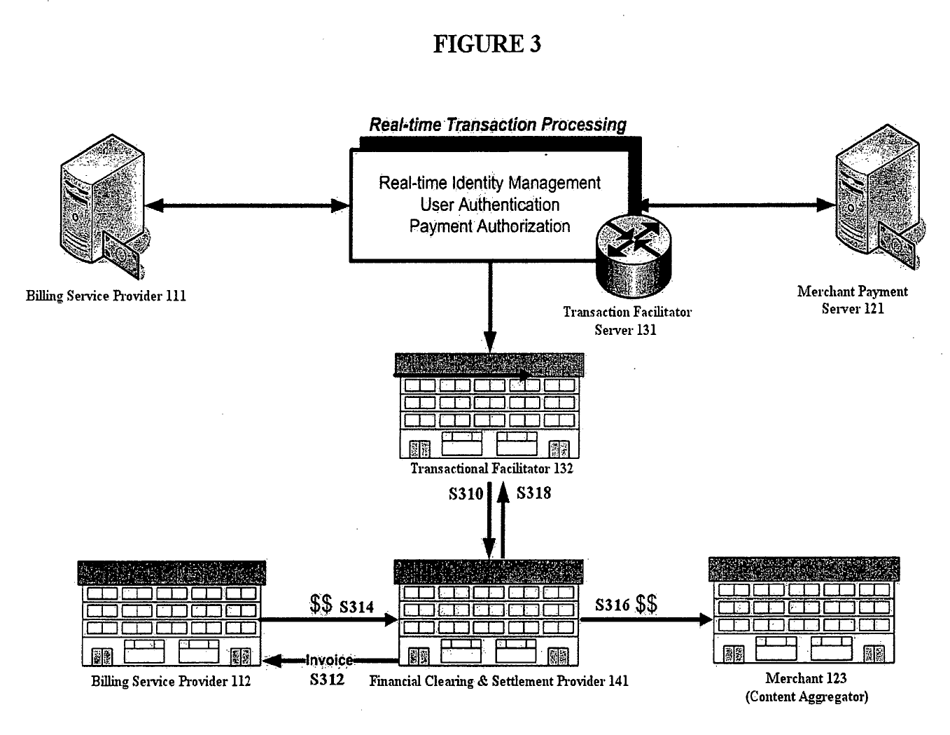

It is understood that the transaction facilitation may be implemented over any common data network(s), such as a packet switching network, accessible by the transaction participants without departing from the spirit and scope of the present invention. The process by which the billing service provider server 111, the merchant payment server 121, the merchant server 122, and the transaction facilitator server 131 communicate is described in greater detail with respect to FIGS. 2 and 3 (discussed below).

FIG. 2 is a flowchart depicting an overall transaction flow of data and communications among the user 101, the merchant server 122, the transaction facilitator server 131, and the billing service provider server 111, according to an embodiment of the present invention, in which the user 101 wishes to download content (e.g., from the merchant server 122). Initially, the user 101 establishes an on-line session, e.g., via the PC 102 or the mobile device 103, with the merchant server 122, which provides a website, typically customized to preferences of the merchant 123. Once the session or connection is established, the user 101 may browse the website provided by the merchant server 122, and select an item displayed on this website for purchase.

Once the user 101 has made a selection, e.g., following the various steps and checkout procedures of the merchant web page(s), a purchase request is transmitted from the user 101 to the merchant server 122 at step S210. The purchase request may include, for example, a numeric product identifier, text identifying the product, a numeric merchant identifier, text identifying the merchant, and a price associated with the product. In an embodiment, the merchant server 122 may also assign the transaction a unique transaction identifier (such as opaque transaction identifier) for added security. This information is transmitted to the transaction facilitator 131 at step S212.

In an embodiment, the checkout procedure presented by the merchant web page(s) includes display of an icon representing the transaction facilitator service described herein as one of a series of payment options selectable by the user. The icon is created by the code snippets added to the merchant website, which were downloaded to the merchant server 122, discussed above.

In step S212, the merchant server 122 redirects the user 101 to the transaction facilitator server 131, through the Internet or other network(s), such as an private intranet, a telephony network, a local area network or the like, capable of interfacing with the Internet (or whatever network the session with the user 101 has been established). In an embodiment, the merchant server 122 also transmits item details to the transaction facilitator server 131, discussed above, along with a merchant uniform resource locator (URL) to which the user 101 should be returned upon authorization of the transaction.

The transaction facilitator server 131 first determines with which billing provider the user 101 is associated, e.g., the billing service provider 112. Initially, the transaction facilitator 131 checks the user's browser. If the user 101 has previously registered with a billing service provider 112, the billing service provider server 111 saves a cookie on the user's browser indicating the registration. If such a cookie is found, the transaction facilitator server 131 redirects the user 101 to the billing service provider server 111 with no further input or action by the user 101.

If there is no such cookie saved on the user's browser, or other identification of a previously registered billing service provider, the transaction facilitator server 131 offers a list of known billing service providers which the user client 101 may choose in order to complete the transaction. In one embodiment, the user 101 then communicates with the transaction facilitator server 131 at step S213, transmitting the IP address or other identification of the user 101 to the transaction facilitator server 131. Based on information associated with this IP address, such as geographic location, the transaction facilitator server 131 outputs a list of potential billing service providers, with which the transaction facilitator service has preexisting billing relationships. The contents of the billing service provider list may be adjusted dynamically according to various relationships with the user 101. For example, the transaction facilitator server 131 may include only those billing server providers within a 10 mile radius of the user 101.

In another embodiment, the billing service provider list may be sent to the merchant server 122 and displayed to user 101 via a website stored on the merchant server 122, e.g., in order to maintain merchant branding. Accordingly, when the user 101 selects the transaction facilitator icon (e.g., pursuant to step S210), the merchant web page(s) may display a list of billing server providers, with which the transaction facilitator service has preexisting billing relationships. This information may be provided to the merchant server 122 through the transaction facilitator server 131 by downloading a database of registered billing service providers from the transaction facilitator server 131. Alternatively, the merchant website may include database query language, which queries a database of registered billing service providers stored on the transaction facilitator server 131. However the list is presented, the user 101 may then select a billing service provider from the list, e.g., the billing service provider 112 and/or a particular branch or office thereof, with which it has an account or desires to use to complete the transaction.

In step S214, the user 101 is routed to the billing service provider server 111. In an embodiment, the URL of the merchant server 122 is also provided to the billing service provider 111, so that the billing service provider 111 is able to send authorization information directly to the merchant server 122, as discussed below with respect to step S219. At step S215, the billing service provider server 111 checks a cookie to determine if the user 101 has previously registered its computing device (e.g., the personal computer 102 or the mobile device 103) with the billing service provider server 111. If not, the billing service provider server 111 displays a registration page at step S216. The user 101 registers the user's computing device, for example, by supplying account information or other authentication data by which the billing service provider server 111 may identify the user 101. The authentication data may include, for example, the user's name and phone number, an email address, a billing service provider account identification number or the like. This registration step may be skipped in subsequent transactions from this particular device.

At step S217, the billing service provider server 111 displays the details regarding the item or service ordered by the user 101, including, for example, the name of the item or service, the quantity and the price. In an embodiment, this information is passed to the billing server provider server 111 by the transaction facilitator server 131 at step S214, along with the URL of the merchant server 122. The billing service provider server 111 may also convert the price of the item or service into the currency that the billing service provider 112 will charge the user. For example, the billing service provider server 111 may determine the appropriate currency based on the geographic data associated with the computing device of the user 101, discussed above. Also in step S217, the user 101 verifies the purchase details, and may then enter a password to authenticate the user's identity and to accept the transaction.

In an embodiment, the billing service provider server 111 can also implement higher levels of authentication, such as calling the user's phone number (stored in the billing service provider's database) from an interactive voice response (IVR) system, which supplies a password for the user to type in on the registration page. Alternatively, the billing service provider 111 can send the password via SMS (short message service) to the user's cellular phone or to a verified e-mail address. The user may later enter this password on the registration and/or authorization page, which requests this password.

In step S218, the billing service provider server 111 checks that the user is authorized to make this purchase, for example, by checking that the user has entered the correct password, and the sum of purchases is less than the user's monthly limit, or that there is sufficient pre-paid balance in the user's account, and/or that the user passes any other credit check. The billing service provider 112 may reserve the purchase amount in the user's balance, or bill daily, or monthly, etc. In step S219, the billing service provider server 111 sends notification to the merchant server 122 (e.g., that the transaction has been approved or denied).

In step S220, the billing service provider server 111 also informs the transaction facilitator server 131 of the authorization response, indicating whether the transaction was approved or denied. The user 101 is then returned to the merchant server 122, based on the received URL of the merchant server 122 or other such unique identifiers, which was earlier transmitted to the billing service provider server 111 by the merchant server 122.

The merchant payment server 121 queries the transaction facilitator server 131 for the authorization response at step S221, and updates its internal records. Alternatively, the transaction facilitator server 131 sends the authorization response without waiting for a query. In step S222, the merchant server 122 delivers the digital item to the user 101 and later informs transaction facilitator server 131 that the transaction was finalized at step S224. Alternatively, for trivial delivery, the merchant payment server 121 queries and finalizes with the transaction facilitator server 131 in one step, and then delivers the digital item.

Although the above embodiments discloses purchased items which are digital content (e.g., ring tones, digital wallpaper, games, video clips, etc.), it is understood that purchased items may also include any types of goods and/or services, which may be delivered to user 101. In the event the transaction includes ordering tangible goods or services, as opposed to digital content, the merchant server 122 schedules delivery of the ordered item, according to conventional on-line order processing techniques.

FIG. 3 is a flowchart depicting an exemplary overall flow of funds among the user 101, the billing service provider 112, the merchant 123, the transaction facilitator 132, and a financial clearing and settlement provider 141, following a purchase transaction, according to an embodiment of the present invention. The merchant 123 may check its amount due daily, e.g., over the web against the database of transaction facilitator. Similarly, the billing service provider 112 may check its amount due daily for those transactions conducted using the system. Of course, the amounts due may be checked at any interval, e.g., continuously, hourly, weekly, monthly, without departing from the spirit or scope of the present invention.

In step S310, at the end of the billing period, the transaction facilitator 132 sends the financial clearing and settlement provider 141 aggregate data of the billing service provider-merchant pairs involved in finalized transactions. This data is stored, for example, in a database accessible to the transaction facilitator server 131. The billing service provider 112 and the merchant 123 may be identified, for example, by 5-character PMN (public mobile network) codes. The aggregate data may be provided by any electronic communication techniques, such as email or file transfer protocol (FTP) of a CSV (comma-separated values) file.

It should also be noted that 5-character PMN codes are typically used in the telecommunications industry for clearing and settlement. PMN codes are generally assigned to mobile operators. However, in the present invention, PMN codes may also refer to banks, merchants and other financial institutions. Currently, PMN codes are assigned manually to new mobile operators. However, in the present invention, new PMN codes may be generated and assigned immediately to be used in transactions with new billing service providers and merchants. The new PMN codes may be generated and assigned by the transaction facilitator server 131.

In step S312, the financial clearing and settlement provider 141 generates an aggregate invoice to the billing service provider 112, in the currency that billing service provider 112 will use in the next step. Then, in step S314, near the end of the settlement period, the billing service provider 112 transfers the appropriate amount to the financial clearing and settlement provider 141.

The settlement period is a period previously agreed upon by the merchant 123, the billing service provider 112, and/or the transaction facilitator 132 by which invoices for transactions are to be sent to the billing service provider 112 and ready for payment by the billing service provider 112. For example, some billing service providers may individually decide that all payments are to be settled within a one month period, while other billing service providers may decide that the settlement period should be three months. The settlement period may be a fixed period agreed upon by the transaction facilitator 132, the billing service provider 112, or the merchant 123. The billing service provider 112 transfers aggregate electronic funds from its accounts to a predetermined account, which was agreed upon with the financial clearing and settlement provider 141.

In step S316, the financial clearing and settlement provider 141 transfers aggregate electronic funds to an account, which was agreed upon with the merchant, at the end of the settlement period. Finally, in step S318, the financial clearing and settlement provider 141 informs the transaction facilitator 132 about the actual amounts transferred. It should be noted that this settlement process may be implemented using servers to transmit accounting information stored in databases for each party involved in the settlement process, including the billing service provider 112, the financial clearing and settlement provider 141, the transaction facilitator 132 and the merchant 123.

In another embodiment, the user 101 may set aside a specification amount of money from the billing service provider 112, which is allotted for online purchases. According to this embodiment, the user 101 selects an amount of money to be set aside, and the billing service provider 112 authorizes the transfer of funds prior to a transaction, and debits this amount from the account of the user 101, e.g., on a transaction by transaction basis. The amount of money set aside may also be refreshed by transferring additional funds from the account of the user 101. When the user 101 makes a purchase from a merchant 123 (whom the transaction facilitator 132 serves), the price of the purchase is immediately withdrawn from this pre-authorized, allotted amount. Similarly, the amount may be withdrawn directly from a previously identified bank account, such as a checking or savings account. As a practical matter, these implementations may function as an online debit card.

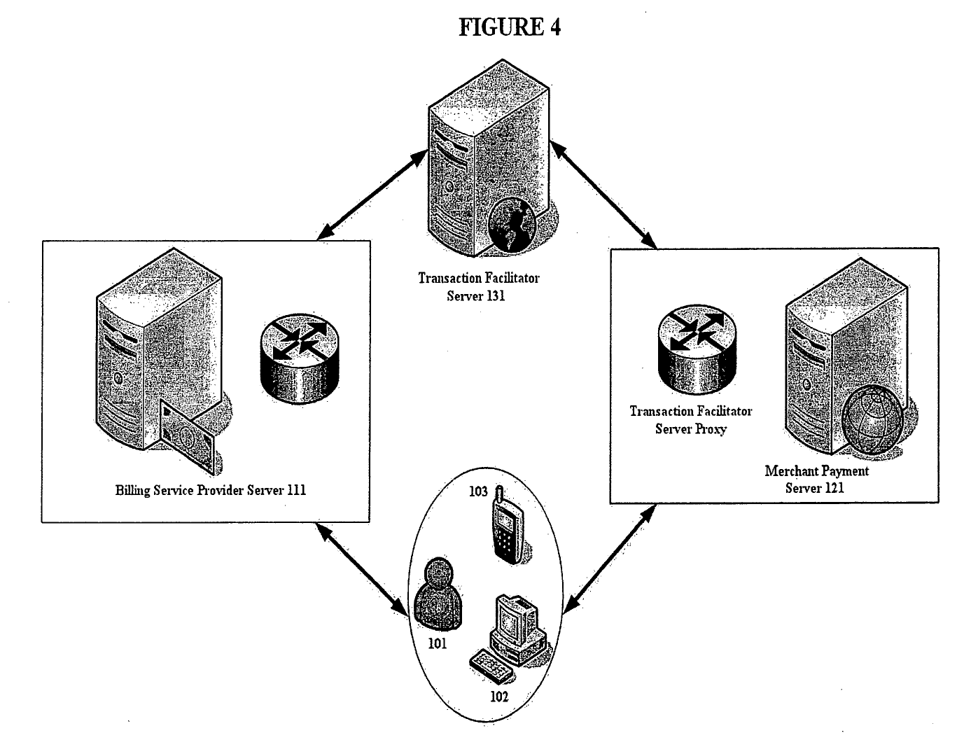

FIG. 4 is a flowchart depicting an exemplary process for providing additional security for the electronic transaction among the user 101, the billing service provider server 111, the merchant payment server 121, and the transaction facilitator server 131, e.g., depicted in FIG. 2. As discussed above, the merchant server 122 and the billing service provider server 111 each communicate with the transaction facilitator server 131, but not directly with each other. As shown in FIGS. 1 and 4, this process allows an independent audit trail of transactions. Also, the burden of ensuring that the other party is bona fide is shifted to an entity that actually has a relationship with that party.

In this environment, the transaction facilitator server 131 authenticates the merchant server 121 and the billing service provider server 111 through client certificates. In an exemplary embodiment, the transaction facilitator server 131 and the billing service provider server 111 store cookies in the user's browser (e.g., executing on the personal computer 102 or the mobile device 103 of the user 101). The cookies may contain an opaque identifier and cryptographic information, such that only the billing service provider server 111 knows the identity of user 101 and can authenticate the user 101.

In one embodiment, the transaction facilitator server 131 checks these cookies using the Four Corner Cipher™ method (a proprietary system, which is not part of this invention) to ensure the security of the electronic transaction, making it difficult for hackers to fake a cookie from the browser of the user 101. The technical features of the Four Corner Cipher™ method are not described or claimed because they are not part of the present invention and disclosure thereof would render them useless for securing the user's private information. The Four Corner Cipher™ method may be substituted with other cryptographic methods which are known in the art.

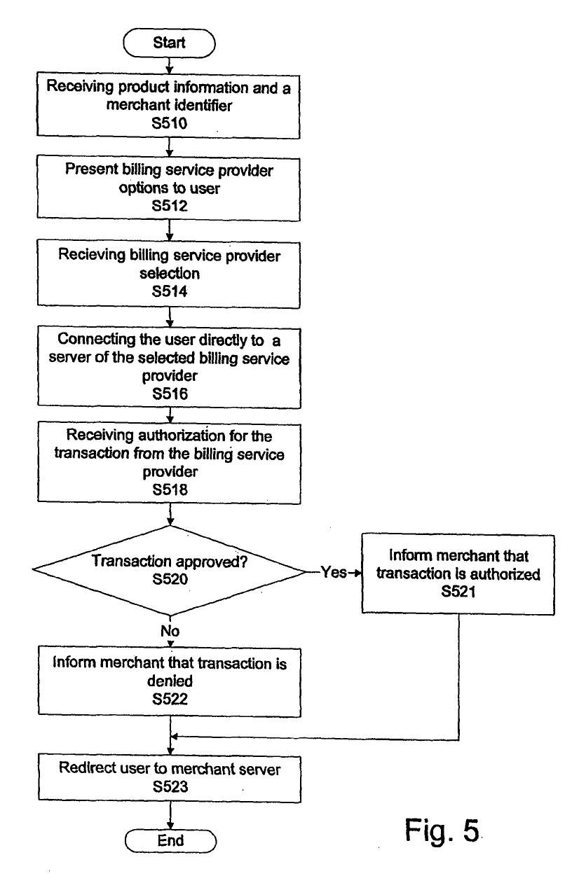

FIG. 5 is a flowchart of an exemplary transaction facilitating process as executed by the transaction facilitator server 131. In step S510, the transaction facilitator server 131 first receives product information and a merchant identifier from merchant server 122. The product information may include a description of the product, the number of products desired, a per unit price and a total price and currency. In step S512, the transaction facilitator server 131 outputs a list of registered billing service providers to the user, including the billing service provider 112, based upon user information (e.g., the geographic location and/or IP address of the computing device of the user 101).

In step S514, the transaction facilitator server 131 receives a billing service provider selection input by the user 101. In an embodiment, the selection is made at the personal computer 102 or the mobile device 103 by simply clicking on a icon or other identifier corresponding to the desired billing server provider (i.e., the billing service provider 112). In step S516, the transaction facilitator server 131 connects user 101 to the billing service provider server 111, which corresponds to the selected billing service provider 112. The billing service provider server 111 then performs user verification and transaction authorization steps, as discussed above with respect to FIG. 2.

In step S518, the transaction facilitator server 131 receives an authorization response, indicating whether the transaction was approved or denied, from the billing service provider server 111. When it is determined at step S520 that the transaction has been approved, the transaction facilitator server 131 informs merchant payment server 121 of the approval at step S520. When it is determined at step S520 that the transaction has been denied, the transaction facilitator server 131 informs merchant payment server 121 of the denial at step S522.

The user 101 is redirected to the merchant payment server 131 at step 523 in either case, either to complete the transaction or, in the event of a denial, to provide the user another payment option. In an embodiment, when the transaction is denied, the user 101 may again select the transaction facilitator option from the merchant's web page, and then select a different billing service provider from the list provided by the transaction facilitator server 131 on the next attempt.

The flowchart discussed above is directed to the process as implemented by the transaction facilitator server 131, although any other party may initiate and implement the process without departing from the spirit or scope of the present invention.

Although the invention has been described with reference to several exemplary embodiments, it is understood that the words that have been used are words of description and illustration, rather than words of limitation. Changes may be made within the purview of the appended claims, as presently stated and as amended, without departing from the spirit and scope of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that, as discussed above, the software implementations of the present invention as described herein are optionally stored on a tangible storage medium, such as a magnetic medium such as a disk or tape; a magneto-optical or optical medium such as a disc; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

### EXAMPLES OF INDUSTRIAL APPLICABILITY

There are various exemplary applications of the present invention. For example, the transaction facilitator system provides an efficient and secure method of routing payment authorization requests over the Internet, or other communications network, between parties that have no prior existing business relationship. The system also polices network transactions based on parameters that may be set by any party to the transaction, as well as regulatory jurisdictions. The system also logs or stores information regarding online transactions without having to store sensitive or proprietary financial data of the user 101 at any party other than the user's billing service provider. The billing service providers likewise may authenticate a user's identity per transaction.

The transaction facilitator system also enables telecommunication service providers, for example, to offer online financial processing services, and enables financial and lending institutions (e.g., banks) to process payments for digital content consumed through a telecommunications network and/or on telecommunications devices. The billing service providers may also modify authentication processes to a security level that suits its particular needs (e.g., password only, SIM card, biometric, etc.). The present invention may also include a single sign-on process, which provides a consistent and secure identity for users. Lastly, the present invention may serve as a home attribute provider for users, which includes a web service that hosts attribute data (e.g., a personal profile service, which provides an identity-based web service that keeps, updates, and offers identity data regarding a user).

1. A method for processing an electronic transaction among a user, a billing service provider, a merchant, and a transaction facilitator using a transaction facilitator server accessible via a data network, the method comprising:
receiving product information and a merchant identifier from a merchant server in response to a purchase request by the user;
connecting the user to a server of the billing service provider for authorizing the transaction based on account information of the user;
receiving an authorization response from the billing service provider server indicating whether the transaction has been approved or denied, without receiving the account information;
redirecting the user to the merchant server, which completes the purchase request based on the authorization response.

2. The method according to claim 1, wherein the merchant identifier comprises a uniform resource locator (URL) of the merchant server.

3. The method according to claim 1, wherein the authorization response is based on identifying the user and determining that funds are available to cover the transaction.

4. The method according to claim 3, wherein identifying the user comprises verifying a predetermined username and a predetermined password.

5. The method according to claim 3, wherein the identity of the user comprises an IP address.

6. The method for processing an electronic transaction according to claim 5, further comprising:
providing the user a list of billing service providers based upon the IP address of the user; and
identifying the billing service provider based on an input by the user.

7. The method for processing an electronic transaction according to claim 1, further comprising:
determining whether a user has registered on the billing service provider server.

8. The method for processing an electronic transaction according to claim 7, further comprising:
redirecting the user to a registration site when the user has not been registered on the billing service provider server.

9. The method for processing an electronic transaction according to claim 1, wherein the billing service provider server further authenticates the user's identity by calling the user's phone number stored on the billing service provider database from an interactive voice response (IVR) system, or by sending the user's cellular phone an SMS, which supplies the user a code to enter on a billing service provide authorization page.

10. The method for processing an electronic transaction according to claim 1, wherein the authorization response is based on the user's account balance information.

11. The method for processing an electronic transaction according to claim 1, wherein completion of the transaction comprises delivering digital content or real content to the user by the merchant.

12. The method for processing an electronic transaction according to claim 1, wherein the billing service provider comprises one of an internet service provider, a telephone service provider, a bank, or a credit card company.

13. The method for processing an electronic transaction according to claim 1, further comprising:
receiving a check balance due request from the merchant via the Internet; and
accessing a database to retrieve balance due data corresponding to the merchant.

14. The method for processing an electronic transaction according to claim 1, further comprising:
receiving a check balance due request from the billing service provider to check balance owed to a plurality of merchants via the Internet; and
accessing a database to retrieve balance due data corresponding to the billing service provider.

15. The method for processing an electronic transaction according to claim 1, further comprising:
sending aggregate transaction data of billing service provider and merchant pairs to a financial clearing and settlement provider, wherein the billing service provider and merchant are identified only by predetermined numerical values.

16. The method for processing an electronic transaction according to claim 1, further comprising:
generating an aggregate invoice, comprising transaction data, to at least one billing service provider.

17. The method for processing an electronic transaction according to claim 1, further comprising:
receiving notification of funds transferred from the billing service provider to the merchant.

18. An apparatus for processing an electronic transaction of a user, the apparatus being accessible via a data network, the apparatus comprising:
a first interface configured to receive product information and a merchant identifier from a merchant server in response to a purchase request by the user;
a second interface configured to connect the user to a server of a billing service provider for authorizing the transaction based on account information of the user, and to receive an authorization response from the billing service provider server indicating whether the transaction has been approved or denied, without receiving the account information;
wherein the user is redirected to the merchant server via the first interface, the merchant server completing the purchase request based on the authorization response.

19. The apparatus according to claim 18, wherein the merchant and the billing service provider are authenticated via cookies in a browser of the user; and
wherein the second interface is further configured to receive a second authentication response verifying an identity of the user based on predetermined password provided by the user.

20. The apparatus according to claim 18, wherein the billing service provider server comprises a database which stores a pre-authorized amount of funds.

21. The apparatus according to claim 18, wherein the billing service provider server comprises a database which stores a credit card identification of the user.

22. A computer readable medium for storing a computer program executed by a server that processes an electronic transaction among a user, a billing service provider, a merchant, and a transaction facilitator using a transaction facilitator server accessible via a data network, the computer readable medium comprising:
a receiving code segment for receiving product information and a merchant identifier from a merchant server in response to a purchase request by the user;
a connecting code segment for connecting the user to a server of the billing service provider for authorizing the transaction based on account information of the user;
an authorization code segment for receiving an authorization response from the billing service provider server indicating whether the transaction has been approved or denied, without receiving the user account information; and
a redirecting code segment for redirecting the user to the merchant server, which processes the purchase request based on the authorization response.

23. The computer readable medium according to claim 22, wherein the account information comprises a credit card number.

24. The computer readable medium according to claim 22, wherein the account information comprises a debit card identifier.

25. A method for implementing an on-line debit card using a billing service provider server accessible via a data network, the method comprising:
storing account information of a user in a database of a billing service provider, the account information including an amount of funds identified by the user for electronic transactions;
receiving a connection with the user to authorize a transaction requested by the user at a merchant website and an identification of the merchant website, the transaction comprising a payment amount; and
authorizing the payment amount based on the account information of the user;
wherein the merchant website receives notice of the authorized payment amount without receiving the account information.

26. The method according to claim 25, further comprising transmitting an authorization response to the user indicating whether the payment amount been authorized.

27. The method according to claim 26, further comprising:
identifying the user, wherein the authorization response is based on the identifying the user.

28. The method according to claim 27, wherein identifying the user comprises verifying a predetermined password.

29. The method according to claim 28, wherein identifying the user further comprises contacting the user by calling or sending an electronic message to the user, and supplying a code for the user to enter.

30. The method according to claim 25, further comprising debiting the payment amount from the identified funds.

31. The method according to claim 30, further comprising refreshing remaining funds to the amount of identified funds.

32. The method according to claim 25, wherein the account information further comprises an IP address.

33. The method according to claim 25, wherein the billing service provider comprises one of an internet service provider, a telephone service provider, a bank, or a credit card company.
